(19) United States
(12) Patent Application Publication
(10) Pub. No.: US 2012/0158560 A1
(43) Pub. Date: Jun. 21, 2012

(54) METHOD AND SYSTEM FOR LEASE PAYMENT CALCULATION

(75) Inventor: Terry Bowdler, San Diego, CA (US)

(73) Assignee: LHPH, LLC, San Diego, CA (US)

(21) Appl. No.: 13/327,304

(22) Filed: Dec. 15, 2011

Related U.S. Application Data
(60) Provisional application No. 61/423,348, filed on Dec. 15, 2010.

(51) Int. Cl. G06Q 40/00; G06Q 30/04

(52) U.S. Cl. 705/34

(57) ABSTRACT

A method or system for executing a leasing plan on a piece of equipment using an actual days basis for a lease charge on a current adjusted capitalized cost on the piece of equipment. A periodic lease payment can be received by the lessor on a given date and the lease charge for the current adjusted capitalized cost (ACC) balance on an actual days basis for a number of days between the given date and a lease-start date or the given date and a date when a previous lease payment was received is calculated. Thereafter, a portion of the periodic lease payment is allocated to the lease charge that has been calculated on an actual days basis and a remainder of the periodic lease payment can be applied to the ACC balance.

### CROSS-REFERENCE TO RELATED APPLICATIONS

This application claims priority of U.S. Provisional Patent Application Ser. No. 61/423,348 having the same title and filed on Dec. 15, 2010, which is included in its entirety herein by reference.

### FIELD OF THE INVENTION

The present invention is related to a method and system for calculating a lease payment and, in particular, to a method and system for creating and executing a lease payment plan on a piece of equipment in which lease charges earned for an adjusted capitalized cost balance for the piece of equipment are calculated using an actual days basis.

### BACKGROUND OF THE INVENTION

Heretofore equipment and vehicle leases have been typically calculated using a money factor at inception of the lease and on an actuarial basis for payoff of the lease. The actuarial basis can be simply calculated and permits easy compliance with Truth in Lending Laws, in particular for consumer closed-end leases that are governed by Regulation M. Closed-end leases place no obligation on the lessee to purchase the equipment or vehicle at the end of the lease (12 CFR Section 213). In addition, Regulation M requires that a lessor disclose the liability of the lessee at the end of the lease if the lessee is liable at the end of the lease term for the difference between the residual value of the leased property and its realized value.

In addition to the above, prior art lease payment plans have typically taken a total lease amount for the equipment or vehicle divided by the term of the lease in order to arrive at periodic lease payments. These periodic lease payments are then requested to be paid on a particular due date for the term of the lease. In the event that the lessee makes payments on the agreed upon due date, the lessor does not incur any additional lease charges for money provided to the lessor of the equipment or vehicle but not yet paid by the lessee. Stated differently, if a lessee makes a late payment, the lessor has essentially loaned money to the lessee for which lease charges are not obtained or paid thereon, Therefore, a leasing plan that allows a lessor to recoup lease charges for money affected by one or more late payments and rewards a lessee for making early payments would be desirable.

### SUMMARY OF THE INVENTION

A method and system for executing a leasing plan on a piece of equipment is provided. The process can include providing a piece of equipment for leasing and determining a periodic lease payment amount for a customer to pay on a periodic basis for the piece of leased equipment. Thereafter, and upon agreement between the lessor and the lessee, a lease agreement is entered into on a lease-start date. In addition, the lease agreement can include a given day of each month on which periodic lease payments are to be paid.

A first periodic lease payment is received by the lessor on a given date and a lease charge for an adjusted capitalized cost (ACC) balance on an ‘actual days basis’ for a number of days between the given date and the lease-start date (i.e. the period) is calculated. It is appreciated that the term ‘actual days basis’ is a term of art having a known meaning by those skilled in the art. Thereafter, a portion of the first periodic lease payment is allocated to the lease charge that has been calculated for the period and a remainder of the first periodic lease payment is applied to the ACC balance to afford a reduction in the ACC balance. It is appreciated that by calculating the lease charge on an actual days basis, if a periodic lease payment is paid early, then the lease charge for the ACC balance is reduced compared to a later date and, as such, more of the lease payment can be applied to the ACC balance. In the alternative, if the lease payment is paid late, i.e. after the agreed upon due date, then the lease charge for the ACC balance increases and more of the lease payment is allocated to paying the lease charge and less to paying off or paying down the ACC balance. As such, the lessee can be rewarded for making the periodic lease payments in a timely manner and the lessor can be financially compensated if a lessee makes late payments.

After the first periodic lease payment has been received and allocated between the lease charge for the period and the ACC balance, a subsequent periodic lease payment can be received on a subsequent date. In addition, a lease charge for the reduced ACC balance using an actual days basis for a subsequent period which is equal to a number of days between a date when a previous periodic lease payment was received and the subsequent date can be calculated. Similar to allocation of the first periodic lease payment, the subsequent periodic lease payment is allocated between lease charge for the reduced ACC balance and the reduced ACC balance.

It is appreciated that this process can continue until only one subsequent periodic lease payment is due and at this time an invoice can be sent to the customer with a total balance that is due for a final payment with respect to the lease payment plan. In the event that the customer has made timely lease payments on or before the due date of each month, then the final lease payment can be equal to or less than the previous subsequent lease payment. In the alternative, if the customer has made one or more late payments, i.e. payments received after the agreed upon due date for each month, a final payment that is greater than the subsequent periodic lease payment can be due. In this manner, a lessor can be compensated for additional lease charges due to late payments by the lessee or, in the alternative, the lessee can be rewarded for making early payments.

### BRIEF DESCRIPTION OF THE DRAWINGS

FIG. 1 is a schematic illustration for a process to calculate a periodic lease payment;

FIG. 2 is a schematic illustration for a prior art lease payment plan;

FIG. 3 is a schematic illustration of a lease payment plan according to an embodiment of the present invention; and

FIG. 4 is a schematic illustration of a lease payment plan according to an embodiment of the present invention.

### DETAILED DESCRIPTION OF THE PRESENT INVENTION

A method and/or system for providing a leasing agreement in which lease payments are calculated and/or allocated per an “actual days basis” is provided. As such, the method and/or system has use for creating and executing a lease payment plan. In some instances, a complex set of computations is required in a timely manner and, as such, a computerized system is required.

In some instances, the method involves first determining a total lease payment before sales tax, the lease payment before tax being equal to a periodic depreciation and a periodic rental. The periodic depreciation can be equal to an adjusted capitalized cost (ACC) minus a residual (R) divided by a term of the lease:

$$periodic depreciation = \frac{A C C - R}{T}$$

where T is the term of the lease.

A gross capitalized cost can be a total value of a piece of property, a piece of equipment, and the like being leased and other items paid for over the lease term such as taxes, fees, breakdown protection, contracts, insurance, and any outstanding prior credit or lease balance. The ACC is the gross capitalized cost less any reduction due to the value of a trade-in allowance, rebate, non-cash credit, down payment, or cash that is paid at the “signing” of the lease. The residual can include a lease-end resale or residual value of the piece of equipment.

The periodic rental can be calculated by determining a sum of lease charges during the term of the lease on an actual days basis divided by the term. The lease charge can be calculated by determining the number of days between payments (i.e., the period) and applying a money factor for the ACC. It is appreciated that the first period will be the number of days between the date of the signing of the lease and the date that the first payment is received. In addition, subsequent periods can vary with the number of days in the month and money factor per day for the period can be applied against a reduced ACC resulting from a previous payment. As such, the lease charge paid by a given lease payment is the sum of the lease charges for each period on an actual days basis. In addition, the periodic depreciation added to the sum of lease charge for the period can amount to a total lease payment before sales tax. In some states a sales tax is required, while in other states a sales tax is not required.

A lease payoff can be determined by calculating a lease charge for a number of days remaining against the ACC as it declines down to the residual over the term of the lease plan. Thus, the method and system can use the actual days basis for calculating the lease payment and calculating the lease balance. In the alternative, a prior art method can be used to calculate a periodic lease payment amount with a final balance calculated at and/or towards the end of the leasing plan/agreement. Therefore, a system in which the lease payment and/or the lease balance are calculated on an actual days basis is provided.

The method and system can include a template for entering information, lookup tables containing information related to the calendar for calculating the period, and a processing unit having algorithms necessary for calculations. The method and system can make the necessary calculations and automatically generate a form that contains all information necessary and desired to comply with Regulation M. Input data can include a term of the lease, an effective date, a periodic payment date, a money factor, rebates, trade-in values, etc. that can be entered through the template. The method and system can then calculate a lease charge which would be paid if all of the payments are to be made on the exact dates the payments are due, and such values can be used for completing a lease statement. It is appreciated that such calculations can be quite complex as the periods vary from month to month, the ACC must be reduced after each payment and the lease charge calculated for the next period. The system and/or process can store such information and keep track of payments as they are made.

In some instances, a payment plan can be set up using a prior art method and system methods, i.e. a calculation of equal periodic payments for the term of the lease plan, with a final payment having an adjusted amount corresponding to any additional lease charges due to late payments or any refund due due to early payments.

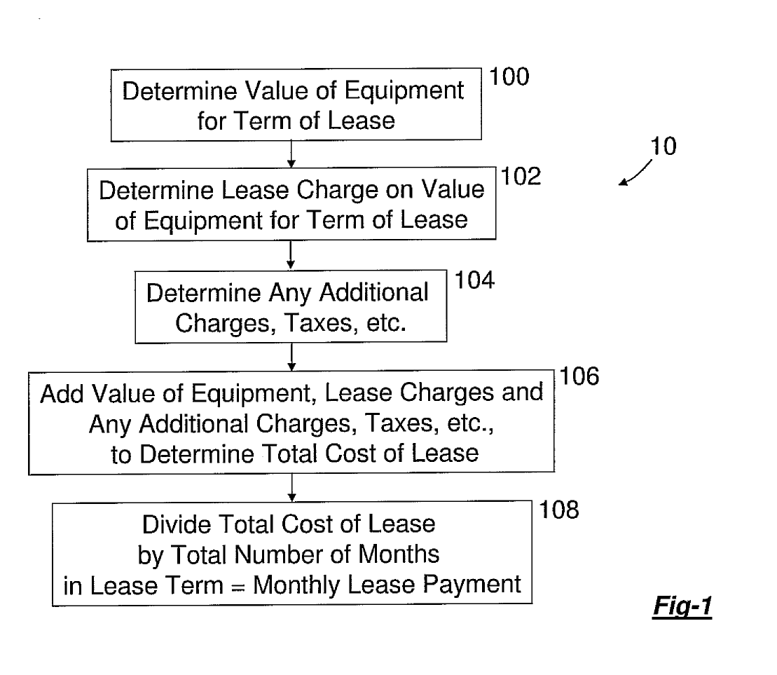

Turning now to FIG. 1, a schematic illustration for a process to calculate a periodic lease payment is shown generally at reference numeral 10. The process 10 can include determining value for a piece of equipment for a lease term at step 100, followed by determining the lease charge on the value of the equipment at step 102. In addition, any additional charges, taxes, etc. can be determined at step 104 and a total cost of the lease can be determined at step 106 by adding the value of the equipment, lease charges, any additional charges, and the like. In some instances, it is appreciated that the total cost of the lease can include an ACC minus a residual. At step 108, the total cost of the lease is divided by a total number of months for a lease term in order to obtain a periodic lease payment to provide to a lessee. It is appreciated that a periodic lease payment can be determined in this manner or in any other manner known to those skilled in the art.

In the alternative to the method of FIG. 1, an actual days basis can be used to calculate a periodic lease payment amount and the date of each month when the payment is due. For example, the method can use an actual days basis to calculate of fixed periodic lease payment amount that would be due every thirty days. In the alternative, and given that different months of the year have different numbers of days, the method can use an actual days basis to calculate how much each payment will be if the payments are paid on the 15^{th} of each month.

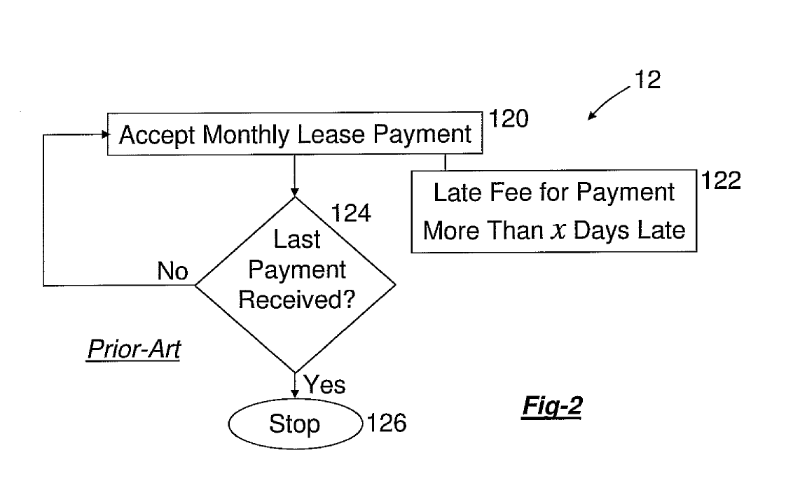

A prior art process and/or system for executing a lease payment plan is shown generally at reference numeral 12 in FIG. 2. The process 12 can include accepting a periodic lease payment at step 120 and determining if a late fee for payment greater than x days after an agreed upon due date is owed at step 122. At step 124, it is determined whether or not a last lease payment has been received and, if so, the lease payment plan is terminated at step 126. In the event that a last lease payment has not been received, the process returns to step 120 when a subsequent lease payment is received. It is appreciated that a payment can be received after the agreed upon due date and yet still not be subject to a late fee. For example, it is not uncommon for payments to be due on the 1^{st} of each month during the term of the lease and a late fee applied only if the payment is received on or after the 10^{th} of the month or the 15^{th} of the month. As such, prior art lease payment plans can result in payments being received late and yet the lessee not having to pay additional lease charges on an outstanding ACC balance, or in the alternative, the lessee not being refunded for less lease charges due when payments are made before or earlier than the due date.

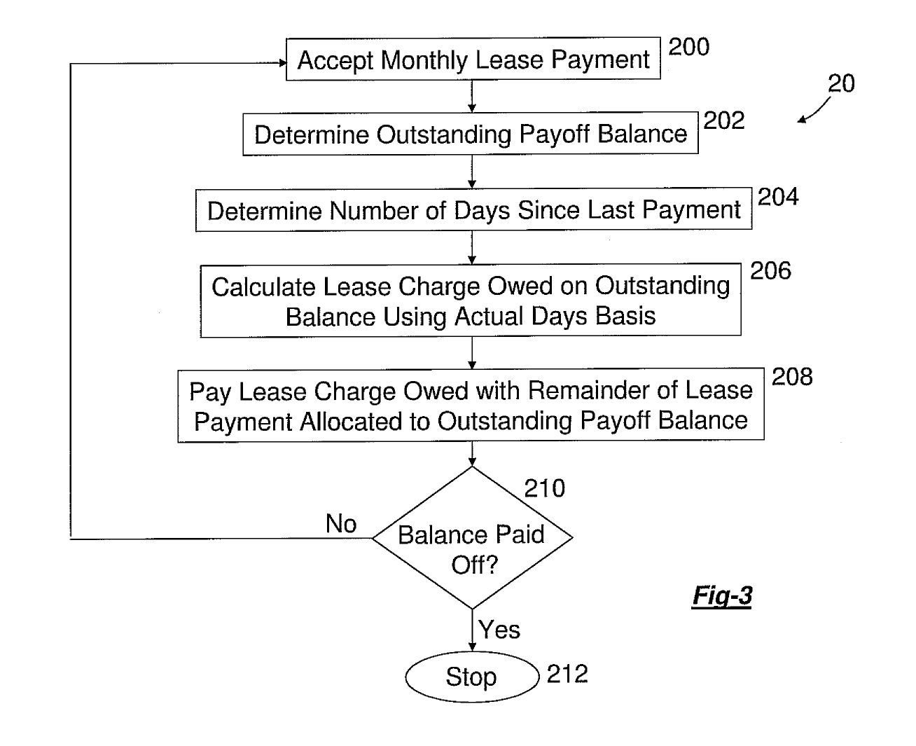

An inventive process for executing a lease payment plan is shown generally at reference numeral 20 in FIG. 3. The process 20 includes accepting a periodic lease payment at step 200. At step 202, an outstanding ACC balance can be calculated and the number of days since a last payment has been received and/or since the “signing” of the lease can be determined at step 204. Once the number of days has been determined at step 204, a lease charge owed on the ACC balance is calculated at step 206 using an actual days basis. Thereafter, the accepted periodic lease payment is used to pay the calculated lease charge owed, with the remainder of the lease payment allocated to pay down the ACC balance. At step 210, it is determined whether or not the outstanding ACC balance has been paid in full, and if not the process can proceed back to step 200. In the event that the balance has been paid off, the lease payment plan is completed at step 212.

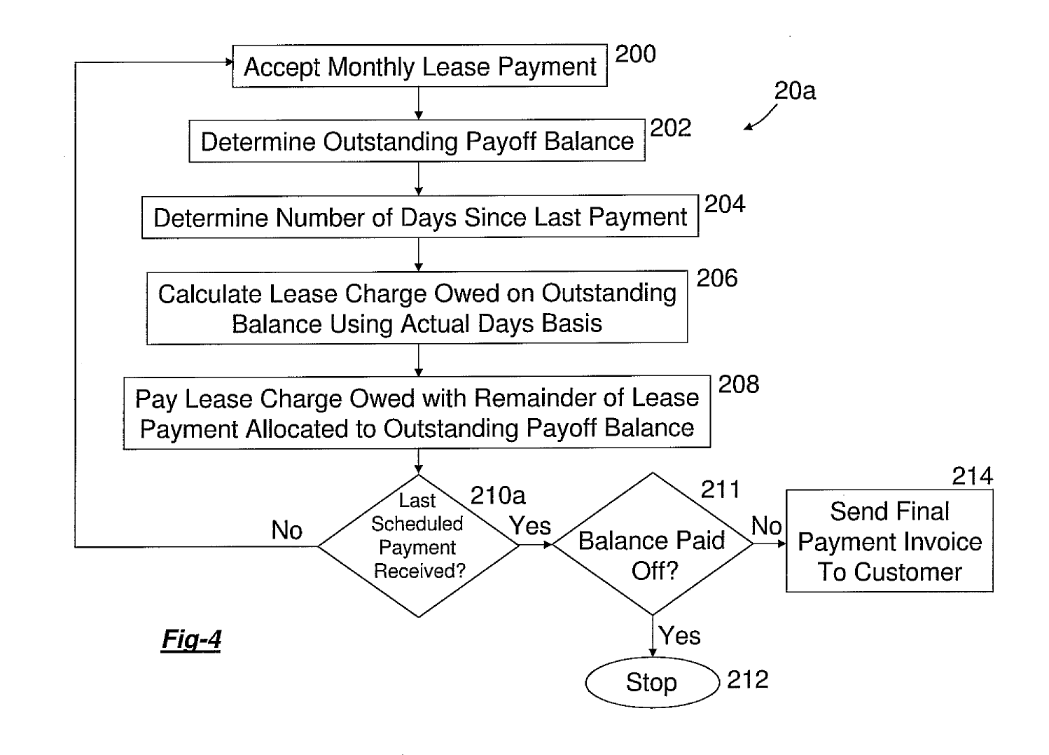

Another embodiment of a method and system for creating and executing a lease payment plan is shown at reference numeral 20a in FIG. 4. The process 20a includes the same steps 200-208 in FIG. 3, followed by determination of whether or not a last scheduled payment has been received at step 210a. If the last scheduled payment has not been received, the process can proceed back to step 200. In the alternative, if the last scheduled payment has been received, the process continues to step 211 in order to determine if the entire ACC balance has been paid in full. If the ACC balance has been paid in full, the lease plan is terminated and/or completed at step 212, whereas if it has not been paid in full the process can include sending a final payment invoice to the customer at step 214. In the alternative, the process can determine a final payoff amount after a next-to-last lease payment has been received such that the last scheduled lease payment, if paid on time, pays the remaining ACC balance in full.

In order to provide an illustrative example of the difference that the inventive process can make with respect to a lease payment plan, Tables 1-3 are provided below.

Looking particularly at Table 1, a simple example of a lease payment plan in which an ACC minus a residual provides a balance of $10,000.00. Using a money factor of 2.917×10⁻⁵ and a term of 12 months, 12 monthly payments of $865.27 can be calculated using processes, methods, etc. known to those skilled in the art. Also shown in Table 1 is the amount of lease charge owed for the outstanding balance for each payment calculated on a monthly basis. It is appreciated that each payment is assumed to be due and paid on a particular due date in a given month and that each payment is made on that exact date. In addition, each payment is used to first pay off the lease charge and the remaining balance of the payment is used to pay down the ACC balance. With 12 equal payments of $865.27, it is shown from Table 1 that the twelfth payment provides an ending balance of zero.

Referring now to Table 2, again a simple example of an ACC minus residual being equal to $10,000.00 is provided, along with 12 equal payments of $865.27 as in Table 1. However, the number of days since signing of the lease or since a last payment is shown in the second column from the left and a refund of $1.90 owed to a customer since all payments were paid on time is shown in the last column on the right.

TABLE 1

| Payment | Payment | Lease | Payment | ACC |
|---|---|---|---|---|
| No. | Received | Charge | on ACC | Balance |
| 0 | | | | 10,000.00 |
| 1 | 865.27 | 58.33 | 806.93 | 9,193.07 |
| 2 | 865.27 | 53.63 | 811.64 | 8,381.42 |
| 3 | 865.27 | 48.89 | 816.38 | 7,565.05 |
| 4 | 865.27 | 44.13 | 821.14 | 6,743.91 |
| 5 | 865.27 | 39.34 | 825.93 | 5,917.98 |
| 6 | 865.27 | 34.52 | 830.75 | 5,087.24 |
| 7 | 865.27 | 29.68 | 835.59 | 4,251.65 |
| 8 | 865.27 | 24.80 | 840.47 | 3,411.18 |
| 9 | 865.27 | 19.90 | 845.37 | 2,565.81 |
| 10 | 865.27 | 14.97 | 850.30 | 1,715.51 |
| 11 | 865.27 | 10.01 | 855.26 | 860.27 |
| 12 | 865.27 | 5.02 | 860.25 | 0.00 |

TABLE 2

| Payment | Days Since | Payment | Lease | Payment | ACC |
|---|---|---|---|---|---|
| No. | Last Payment | Received | Charge | on ACC | Balance |
| 0 | | | | | 10,000.00 |
| 1 | 31 | 865.27 | 59.41 | 805.86 | 9,194.14 |
| 2 | 28 | 865.27 | 49.34 | 815.93 | 8,378.21 |
| 3 | 31 | 865.27 | 49.78 | 815.49 | 7,562.72 |
| 4 | 30 | 865.27 | 43.48 | 821.79 | 6,740.94 |
| 5 | 31 | 865.27 | 40.05 | 825.22 | 5,915.72 |
| 6 | 30 | 865.27 | 34.01 | 831.26 | 5,084.46 |
| 7 | 31 | 865.27 | 30.21 | 835.06 | 4,249.40 |
| 8 | 31 | 865.27 | 25.25 | 840.02 | 3,409.38 |
| 9 | 30 | 865.27 | 19.60 | 845.67 | 2,563.72 |
| 10 | 31 | 865.27 | 15.23 | 850.04 | 1,713.68 |
| 11 | 30 | 865.27 | 9.85 | 855.41 | 858.27 |
| 12 | 31 | 865.27 | 5.10 | 860.17 | −1.90 |

In contrast, Table 3 illustrates the same lease payment amount, i.e. an ACC balance of $10,000.00, with lease payment numbers 2 and 4 being paid late, i.e. payment 2 was paid 38 days after payment 1 and payment 4 was paid 40 days after payment 3. Comparison of Table 3 with Table 2 shows that the lease charge for payments 2 and 4 increases since the lease charge is calculated on an actual days basis. Accordingly, less of the lease payment is allocated to the ACC balance and thus at the end of the lease payment plan, a balance of $13.34 is still owed to the lessor. It is appreciated that instead of accepting a twelfth lease payment of $865.27, the lessor could accept the eleventh lease payment of $865.27 and then send out a final invoice for the amount of $875.08 plus any lease charge between the date of the eleventh payment and the agreed upon due date for the twelfth payment.

TABLE 3

| Payment | Days Since | Payment | Lease | Payment | ACC |
|---|---|---|---|---|---|
| No. | Last Payment | Received | Charge | on ACC | Balance |
| 0 | | | | | 10,000.00 |
| 1 | 31 | 865.27 | 59.41 | 805.86 | 9,194.14 |
| 2 | 38 | 865.27 | 66.96 | 798.31 | 8,395.83 |
| 3 | 21 | 865.27 | 33.79 | 831.48 | 7,564.36 |
| 4 | 40 | 865.27 | 57.99 | 807.28 | 6,757.08 |
| 5 | 31 | 865.27 | 40.14 | 825.12 | 5,931.96 |
| 6 | 30 | 865.27 | 34.11 | 831.16 | 5,100.79 |
| 7 | 31 | 865.27 | 30.30 | 834.96 | 4,265.83 |
| 8 | 31 | 865.27 | 25.34 | 839.92 | 3,425.91 |
| 9 | 30 | 865.27 | 19.70 | 845.57 | 2,580.34 |
| 10 | 31 | 865.27 | 15.33 | 849.94 | 1,730.40 |
| 11 | 30 | 865.27 | 9.95 | 855.32 | 875.08 |
| 12 | 21 | 865.27 | 3.52 | 861.75 | 13.34 |

As illustrated by Tables 1-3, the method and a system for implementing the process, provide for a lessor to be properly reimbursed for outstanding ACC balances when payments are made late or, in the alternative, reward a lessee for making early payments.

It is appreciated that Tables 1-3 provide only one example of how such a lease payment plan can be executed and that other examples and processes can be created and implemented, and still fall within the scope of the instant application so long as lease charge is calculated on an actual days basis. As such, it is appreciated that the figures, examples, and the like are for illustrative purposes only and that the scope of the invention is provided by the claims.

Furthermore, it is appreciated that a computerized system, machine, and the like having a memory with a database, lookup tables, etc., and a processing unit operable to perform calculations can be provided in order to transform the data provided by a lessor into a lease payment plan. Such data provided can include but is not limited to depreciation fees, finance fees, sales taxes, annual interest rates, money factors, and the like known to those skilled in the art of leasing equipment and/or lending money for leased equipment.

I claim:

1. A process for executing a leasing plan on a piece of equipment, the process comprising the steps of:
a. entering into a lease with a customer for the piece of equipment on a lease-start date, the lease having an agreed upon periodic lease payment;
b. receiving a lease payment for the piece of equipment on a given date;
c. calculating a lease charge for an adjusted capitalized cost (ACC) balance for the piece of equipment and on an actual days basis for a number of days between the given date and the lease-start date or a prior-payment date when a previous lease payment was received;
d. allocating a portion of the lease payment to the lease charge and allocating a remainder of the lease payment to the ACC balance and calculating a reduced ACC balance;
e. repeating steps b and c until a last lease payment is received; and
f. calculating a remaining balance and sending a final invoice to the customer if a positive final balance is due or sending a refund to the customer if a negative final balance is due.

2. The process of claim 1, wherein the lease payment includes at least one of a depreciation fee, a finance fee and a sales tax.

3. The process of claim 2, wherein the depreciation fee is an initial ACC amount less a residual amount divided by a term of the leasing plan.

4. The process of claim 3, wherein the finance fee is a function of a money factor.

5. The process of claim 4, wherein the lease payment includes a sales tax amount.

6. The process of claim 1, further including the step of providing a computer having a data input module, a processing unit and a memory.

7. The process of claim 6, wherein the data input module receives a lease payment amount and the given date.

8. The process of claim 7, wherein the processing unit calculates the lease charge, allocates the lease payment, and calculates the reduced ACC balance and remaining balance.

9. The process of claim 8, wherein the reduced ACC balance is stored in the memory.

10. A process for creating and executing a lease payment plan on a piece of equipment, the process comprising:
a. providing a piece of equipment for leasing;
b. determining a periodic lease payment amount for a customer to pay on a periodic basis for the leasing of the piece of equipment;
c. entering into a lease agreement with the customer on a lease-start date for the piece of equipment and the periodic lease payment amount;
d. receiving a first periodic lease payment on a given date;
e. calculating a lease charge for an adjusted capitalized cost (ACC) balance on an actual days basis for a number of days between the given date and the lease-start date;
f. allocating a portion of the first periodic lease payment to the lease charge and allocating a remainder of the lease payment to the ACC balance and thereby providing a reduced ACC balance;
g. receiving a subsequent periodic lease payment on a subsequent date;
h. calculating a lease charge for the reduced ACC balance on an actual days basis for a number of days between a date when a previous periodic lease payment was received and the subsequent date;
i. allocating a portion of the subsequent periodic lease payment to the lease charge for the reduced ACC balance and allocating a remainder of the subsequent lease payment to the ACC balance;
j. repeating steps g-i until only one subsequent periodic lease payment is due; and
k. sending an invoice to the customer with a total balance due for a final payment for the lease payment plan.

11. The process of claim 10, wherein the lease payment includes at least one of a depreciation fee, a finance fee and a sales tax.

12. The process of claim 11, wherein the depreciation fee is an initial ACC amount less a residual amount divided by a term of the leasing plan.

13. The process of claim 12, wherein the finance fee is a function of a money factor.

14. The process of claim 13, wherein the lease payment includes a sales tax amount.

15. A process for creating and executing a lease payment plan on a piece of equipment, the process comprising:
a. providing a computer having a data input module, memory and processing unit;
b. calculating a periodic lease payment amount for the piece of equipment using the processing unit and storing the periodic lease payment in the memory;
c. entering into a lease agreement with the customer on a lease-start date for the piece of equipment and the periodic lease payment amount;
d. receiving a first periodic lease payment on a given date;
e. calculating a lease charge for an adjusted capitalized cost (ACC) balance on an actual days basis for a number of days between the given date and the lease-start date using the processing unit;
f. allocating a portion of the first periodic lease payment to the lease charge, allocating a remainder of the lease payment to the ACC balance and calculating a reduced ACC balance;
g. storing the reduced ACC balance in the memory;
h. receiving a subsequent periodic lease payment on a subsequent date;
i. calculating a lease charge for the reduced ACC balance on an actual days basis for a number of days between a date when a previous periodic lease payment was received and the subsequent date using the processing unit;
j. allocating a portion of the subsequent periodic lease payment to the lease charge for the reduced ACC balance, allocating a remainder of the subsequent lease payment to the reduced ACC balance, calculating a new reduced ACC balance;
k. storing the new reduced ACC balance in the memory;
l. repeating steps h-k while using the new reduced ACC balance as the reduced ACC balance in steps i and j until only one subsequent periodic lease payment is due using the processing unit and memory; and
m. sending an invoice to the customer with a remaining balance due for a final payment for the lease payment plan.
